(19) United States
(12) Patent Application Publication
(10) Pub. No.: US 2019/0102836 A1
(43) Pub. Date: Apr. 4, 2019

(54) SYSTEM AND METHOD FOR ANALYZING CROWDFUNDING PLATFORMS

(71) Applicant: CROWDBUREAU, New York, NY (US)

(72) Inventors: Kim Wales, New York, NY (US); Julien Buty, Calonges (FR); Harald Frost, Gilching (DE)

(21) Appl. No.: 16/151,491

(22) Filed: Oct. 4, 2018

Related U.S. Application Data
(60) Provisional application No. 62/568,105, filed on Oct. 4, 2017.

(51) Int. Cl. G06Q 40/02; G06Q 30/02; G06F 17/30

(52) U.S. Cl. CPC G06Q 40/025; G06F 17/30525; G06Q 30/0279

(57) ABSTRACT

Systems and methods are provided for analyzing crowdfunding platforms. The method includes connecting, using an electronic device, to a plurality of individual lending platforms, and retrieving loan book data from each of the individual lending platforms, storing the loan book data, using a memory coupled to the electronic device, wherein the loan book data includes metadata generated in a Structured Query Language database, and wherein the metadata includes a name of a platform associated with the loan book data and a list of data attributes. The method further includes transforming, using a processor coupled to the electronic device, the loan book data from each of the platforms such that the transformed loan book data uses common data, reading, using the processor, the transformed loan book data, and documenting, for each pair of platform and attribute, a destination unified data attribute.

### CLAIM OF PRIORITY

This application is a United States non-provisional application and claims priority to U.S. Provisional Patent Application No. 62/568,105, filed Oct. 4, 2017 and herein incorporated by reference in its entirety.

### FIELD OF THE EMBODIMENTS

This invention relates to loan analyzing and, in particular, to analyzing data pertaining to peer-to-peer lending and equities crowdfunding platforms.

### BACKGROUND OF THE EMBODIMENTS

From Main Street storefronts to high tech startups, two third of new jobs over recent decades have been created by American small businesses and medium businesses. The ability for individuals to pursue an idea, to start a company, and to grow a business is the foundation of the U.S. economy.

The Obama Administration sought to ensure that the benefits of the United States' continuing economic recovery from the 2008 financial recession, reach all Americans through the Jumpstart Our Business Startups Act, 2012, that allows for securities crowdfunding (equity and debt) online through an intermediary (broker-dealer or registered funding platform). This initiative spurred on another 40 countries to change their securities laws to address this crisis. It is important that consumers and small and medium sized businesses have broad access to safe and affordable credit and equity facilities. Without capital formation, entrepreneurs cannot put innovative ideas into action. Without sufficient funding Americans cannot grow their businesses to create new jobs and opportunities for the next generation.

Since the launch of the first peer-to-peer lending platforms in 2004 by United Kingdom based platform Zopa, followed by Prosper Marketplace in 2007, to Kickstarter in the United States as the first donation and rewards based platform in 2009, crowdfunding has become exceedingly popular. This “democratization of fundraising” allows entrepreneurs and innovators the opportunity to raise vital capital from individuals and institutions around the world, bypassing the traditional methods of fundraising from pre-existing relationships of friends, family and investors. Kickstarter, Indiegogo and GoFundMe are familiar names accounting for billions in rewards and donations. These crowdfunding platforms are only a small portion of a rapidly growing industry globally. If someone were to plan a crowdfunding campaign, that person would likely first turn to one of these platforms.

Staff, alumni and students at universities across the United States in turn are beginning to leverage these new mechanisms to fund tuition, projects and businesses through exclusive crowdfunding platforms hosted by their schools.

Most of the crowdfunding platforms can be assigned to the four crowdfunding categories presented below, even though the business models sometimes differ strongly within these groups below is an overview of each. In the crowd investing category, for example, there are huge differences between the business models dependent on which part of the JOBS Act is being leveraged. Note, that one or more models can be adopted in order to create a “graduation” model that serves as incubators throughout the lifecycle of a project or business.

Crowdfunding Definitions
1. Crowd Donation: Funding contributions are donations that do not earn any direct measurable compensation or perk. Examples include social, charitable and cultural projects. Crowd donating can also be used to raise funds for political campaigns. For crowd donating to be successful, it is imperative that an emotional bond be established and maintained between the providers of capital and the recipients.
2. Crowd Rewards: Crowd rewards include creative and cultural projects as well as sport projects. However, commercial projects can also be subsumed under this category. With this type of financing, the contributor receives a perk (e.g., reward) in the form of products, works of art, or services. There are no limits to the creativity of the parties looking for funding.
3. Crowd Investing (Equity/Debt): Instead of financing a project, crowd investing focuses on purchasing equity (common shares) or debt (e.g., convertible notes, mini-bonds) in a company. Crowd investing also offers investors with only limited amounts to invest the opportunity to support the growth of startups, and small- and medium-sized businesses or lifestyles. In return, these investors receive shares in the company or interest repayment based on specified terms. In the case of equity investments, these are often silent partnerships where the investors only have no or limited voting rights.
4. Crowd Lending/Peer-to-Peer Lending: Crowd Lending mainly refers to the financing of companies or private individuals (e.g. life styles, student loans, real estate, cars, etc.) with loans (borrowed capital). In return for their loan, lenders expect a risk-adjusted return on their investment. As products and business models have evolved, the investor base for online marketplace lenders has expanded to institutional investors, hedge fond, and financial institutions.

Dependent on country, securities based crowdfunding encompasses the selling shares (common stock) and all forms of credit including, but not limited to, mini-bonds, peer-to-peer lending, convertible notes, etc.

This next section provides an overview of the primary business models in online peer-to-peer lending as well as the structures used to fund this activity.

Companies in this industry have developed three primary business models: (1) direct lenders that originate loans to hold in their own portfolios, commonly referred to as balance sheet lenders; (2) platform lenders that partner with an issuing depository institution to originate loans that are funded by all types of lenders and then, in some cases, purchase the loans for sale to investors as whole loans or by issuing securities such as member-dependent notes: and (3) the third business model includes the aforementioned and illustrates the transfer rights and obligations in securitization.

Direct lenders that do not rely on depository institutions to originate loans are generally required to obtain licenses from each state in which they lend. Direct lenders that use state lending licenses to originate loans directly are not subject to a federal banking regulator's supervisory authority, except to the extent the lenders may be subject to CFPB supervision.

### SUMMARY OF THE EMBODIMENTS

According to an aspect of the present invention, a method for analyzing crowdfunding platforms is provided. The method includes connecting, using an electronic device, to a plurality of individual lending platforms, and retrieving loan book data from each of the individual lending platforms, storing the loan book data, using a memory coupled to the electronic device, wherein the loan book data includes metadata generated in a Structured Query Language database, and wherein the metadata includes a name of a platform associated with the loan book data and a list of data attributes. The method further includes transforming, using a processor coupled to the electronic device, the loan book data from each of the platforms such that the transformed loan book data uses common data, reading, using the processor, the transformed loan book data, and documenting, for each pair of platform and attribute, a destination unified data attribute.

It is an object of the present invention to provide the method for analyzing crowdfunding platforms, wherein the metadata further includes a timestamp for when the loan took data has been received.

It is an object of the present invention to provide the method for analyzing crowdfunding platforms, wherein the list of attributes is associated with each borrower listing and loan origination associated with the platform.

It is an object of the present invention to provide the method for analyzing crowdfunding platforms, wherein the common data is selected from the group consisting of: a common language; a common currency; a common time zone; common units; and common numeric ranges.

It is an object of the present invention to provide the method for analyzing crowdfunding platforms, wherein the storing the loan book data further includes storing the loan book data, for each platform, in its natural state, in real time.

It is an object of the present invention to provide the method for analyzing crowdfunding platforms, wherein the documenting is performed according to a mapping table.

It is an object of the present invention to provide the method for analyzing crowdfunding platforms, wherein the method further includes predicting if a loan associated with a platform is likely to be repaid or not.

According to another aspect of the present invention, a system for analyzing crowdfunding platforms is provided. The system includes an electronic device configured to connect to a plurality of individual lending platforms and retrieving loan book data from each of the individual lending platforms, a memory coupled to the electronic device, the memory configured to store the loan book data, wherein the loan book data includes metadata generated in a Structured Query Language database, and wherein the metadata includes a name of a platform associated with the loan book data and a list of data attributes, and a processor, coupled to the electronic device, the processor configured to transform the loan book data from each of the platforms such that the transformed loan book data uses common data, read the transformed loan book data, and document, for each pair of platform and attribute, a destination unified data attribute.

It is an object of the present invention to provide the system for analyzing crowdfunding platforms, wherein the metadata further includes a timestamp for when the loan book data has been received.

It is an object of the present invention to provide the system for analyzing crowdfunding platforms, wherein the list of attributes is associated with each borrower listing and loan origination associated with a primary platform listed and identified across other platforms.

It is an object of the present invention to provide the system for analyzing crowdfunding platforms, wherein the common data is selected from the group consisting of: a common language; a common currency; a common time zone; common units; and common numeric ranges.

It is an object of the present invention to provide the system for analyzing crowdfunding platforms, wherein the memory if further configured to store the loan took data, for each platform, in its natural state, in real time.

It is an object of the present invention to provide the system for analyzing crowdfunding platforms, wherein the processor is configured to document according to a mapping table.

It is an object of the present invention to provide the system for analyzing crowdfunding platforms, wherein the processor is further configured to predict if a loan associated with a platform is likely to be repaid or not.

It is an object of the present invention to provide the system for analyzing crowdfunding platforms, wherein the electronic device is selected from the group consisting of: a desktop computer, a laptop computer; a tablet computer; and a smartphone.

It is an object of the present invention to provide the system for analyzing crowdfunding platforms, wherein the system further includes a graphical user interface, and wherein the memory is further configured to store a digital application configured to enable a user to access the destination unified data attributes, using the graphical user interface.

### BRIEF DESCRIPTION OF THE DRAWINGS

FIG. 1 shows a block flow diagram of a method/system for analyzing crowdfunding platforms is illustratively depicted, according to an embodiment of the present invention.

FIG. 2 shows a screenshot of a login screen for a digital application for analyzing crowdfunding platforms, according to an embodiment of the present invention.

FIG. 3 shows a screenshot of an alert system configuration screen for the digital application for analyzing borrower capital limits and investor investment limits based on regulatory mandates and specific crowdfunding business models across platforms by using an encrypted unique identifier, according to an embodiment of the present invention.

FIG. 4 shows a screenshot for setting up a user account for the digital application for analyzing crowdfunding platforms, according to an embodiment of the present invention.

FIG. 5 shows a screenshot for configuring alerts for the digital application for analyzing crowdfunding platforms, according to an embodiment of the present invention.

FIG. 6 shows a screenshot for configuring alerts for the digital application for analyzing crowdfunding platforms, according to an embodiment of the present invention.

FIG. 7 shows a screenshot of a platform, using the digital application for analyzing crowdfunding platforms, according to an embodiment of the present invention.

FIG. 8 shows a screenshot of alerts for a platform, using the digital application for analyzing crowdfunding platforms, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Recent legislative changes have made it possible for companies in the United States to raise the capital they need by means of peer-to-peer marketplace lending and securities (equity and debt (e.g., peer-to-peer lending)) crowdfunding. This allows for accredited and non-accredited investors to buy and sell securities in Small Cap Private Companies and Non-Publicly Traded Funds. The present invention describes an integrated approach for addressing the challenges of this market, including the development of ratings and the creation of an online financial technology platform that provides a transparent framework for investors and creates the mechanisms for the market participants to comply with regulations and benchmark their performance. The design of the rating framework starts with data collection, consolidation, and unification of the peer-to-peer market place lending and securities (equity and debt) crowdfunding market.

According to an embodiment, the present system has two components.

The first component is the technology stack. According to an embodiment, three subcomponents make up the technology stack (system) that proceeds to crawl and yields the first subcomponent, which is to collect data; followed by sanitization feature that allows for the second subcomponent, consolidation; and the third subcomponent, unification of loan book data from securities crowdfunding platforms, known as marketplace lenders, peer-to-peer lenders, and crowdfunding platforms (equity and debt). It is noted, however, that the nomenclature often changes based on the origin of country.

The second component involves data collection. According to an embodiment, the crawling of peer-to-peer loan book data is collected in the first layer/component in each country's natural language (e.g., Chinese, Hindi, English and more); computer encoding; and computer format.

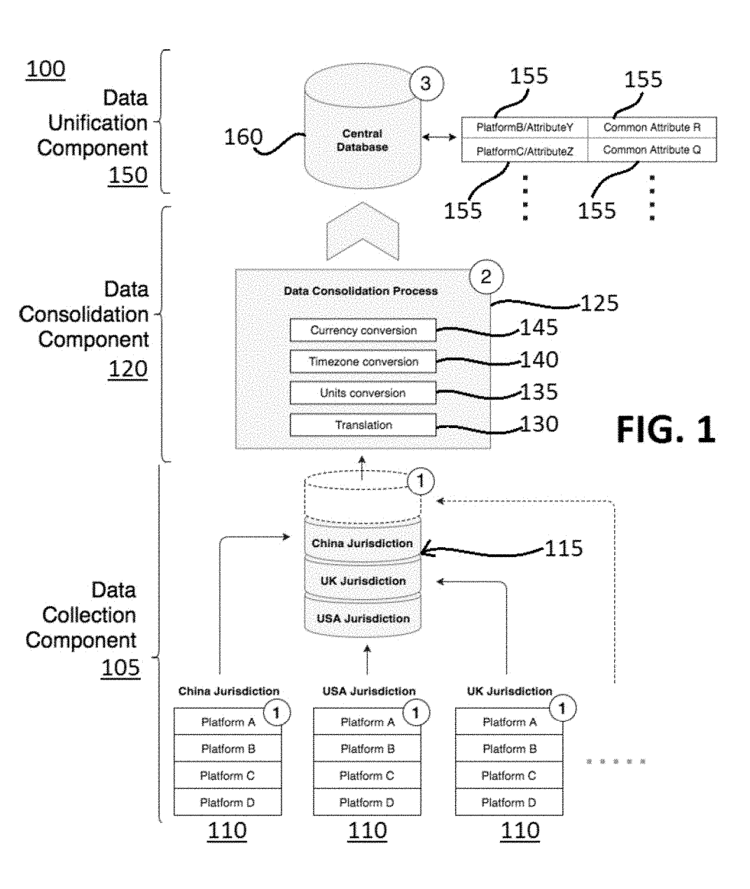

Referring now to FIG. 1, a block/flow diagram of a method/system 100 for analyzing crowdfunding platforms is illustratively depicted, in accordance with an embodiment of the present invention.

Globally, over 2500 platforms have started issuing consumer personal loans, small- and medium-sized business loans, real estate loans (commercial and residential), student loans, agriculture/agribusiness loans, solar/renewable energy loans and automobile loans via web enabled lending platforms. Financial loan data are published by each lending platform as each borrower is listed on the platform seeking funding. The marketplace lender/peer-to-peer lender updates and releases its data on a different time intervals through different mediums, in different formats, and across different jurisdictions.

Some platforms provide the data through the WebSocket real-time protocol (essentially pushing new loan data and events to protocol subscribers). Others through a RESTful API where a script could pull new loan data on a pre-defined interval-time series (hourly, 3-hours, daily, monthly, quarterly, etc.). Dependency of output is based on the age of the peer-to-peer lending platforms, business model of the peer-to-peer lending platforms (some simply update their loan listings at the time the borrowers “ask” for a loan amount, update an event when an investor lends money toward the “ask” amount), and when the loan originates (e.g., the loan is fully funded) on a public web page, providing a comma-separated values (CSV) file for download. Other platforms provide for direct application programming interfaces (APIs) for retail and institutional investors and partners.

These peer-to-peer lending platforms offer their data in different formats, including, but not limited to, JSON, line-delimited-JSON, CSV, TSV, Excel and HTML. Each format is provided with different possible encoding including, but not limited to, UTF-8, BIG5, Latin-1 and GBK.

Each platform data may be in a different language (Chinese, English, Hindi, French, Spanish, etc.). Any numeric value may be denominated in different units and these units may be in various currencies (e.g., US Dollar, Renminbi, Euro, British Pound Sterling, Rupee; etc.) and have a different numeric range. The numeric range may include salaries (e.g., 0-1 million versus 0-1 thousand).

The problem is derived from this situation when an entity (e.g., automated or human) desires to comprehend this data in a consolidated macro to micro level, across all platforms for the peer-to-peer lending financial industry (e.g., regulators, investors). In this instance, “comprehend” refers to the generation of statistics and allowing a high degree of comparativeness qualitative and quantitative across platforms' data.

The heretofore described complexities complicate attempts to analyze risk management in crowdfunding platforms. The solution to address this problem is comprised of three-layer components working together. Illustrated in FIG. 1 is the solution for the collection, consolidation and unification.

According to an embodiment, the data collection component 105 includes a set of custom-made scripts that connect to an individual lending platform and retrieve its loan book data. Each script complies with and follows the peer-to-peer lending platform data release schedule, medium, and format 110. Once the data from each platform is received, they are stored (archived) in their natural state, in real time, along with meta-data generated in a data collection SQL database 115. According to an embodiment, metadata includes: a timestamp for when the data has been received; the name of the platform; and the list of its data attributes for each borrower listing and subsequent loan origination. According to an embodiment, each borrower listing and/or the loan origination are associated with a primary platform listed and identified across other platforms. At this stage, all platform data are saved using the same encoding (e.g., UTF-8), and the same format (e.g., JSON), but each retain its unique and verifiable data attributes keys (e.g., loan interest may be represented as “LoanInterest” or “loan_itrst”). This archival step of the data collection component 105 allows for auditing of the original data footprint for compliance purposes prior to sanitization.

According to an embodiment, the data consolidation component 120 addresses the need for transforming the data to use a common language, currency, time zone, common units and numeric ranges. The data consolidation component pulls data from the data collection component 105, reads them and, during a data consolidation process 125, applies various transformations, such as the list of the examples below:
1. Data in natural language (e.g., loan type/usage, interest rate, loan amount, repayment terms, and more.) is captured in the first instance in the native language and archived for audit purpose and then translated 130 into English. The monetary denomination type data such as loan amount, premiums and other data are captured in the native language and remain in native language for research reports and benchmarks as such due to currency fluctuations. Typically, this will not convert 135 into US Dollar, unless required and then both denominations will be presented with date/time stamp for back testing.
2. Time zones are converted 140 to the UTC time zone.
3. Borrowers income information, interest rate and other numeric information will be converted 145 to use a single floating—point format (e.g., “18K” to “18000.00”, “10%” to “0.1”). At this stage all data has been converted to a common format, but each platform still remains with its original and unique set of data attribute key.

According to an embodiment, all of this data is pushed and stored into a queue, to be consumed by the last component, the data unification component 150.

According to an embodiment, the data unification component 150 reads data from a queue populated by the data collection component 105. Based on a mapping table, documenting for each different platform data attribute pair 155 (e.g., platform A/attribute Y) its destination unified data attribute, the data unification component 150 populates a central Structured Query Language (SQL) database 160 for all platform/attribute pairs 155.

This results in a central database 160 storing different platform data in a new unified format, from which macro-level statistics and comparison analysis can be achieved with accuracy at a less than 1 percent error rate.

Such a solution as that shown in FIG. 1 allows for transparency at the transaction level for loan data in near real-time, and the normalization and standardization of data, thus allowing for the creation of industry-wide comparisons, valuations, pricing activities, and statistics generation across platforms, across jurisdictions, and across regional settings. For further illustration, please refer to Appendix I.

According to an embodiment, the present method system 100 includes, e.g., comparing the average interest rate of a platform A in jurisdiction Y, to the average interest rate of another platform B in a jurisdiction Z; and averaging all platform loan default rates for an entire jurisdiction or region.

According to an embodiment, the present method/system 100 includes, e.g., the feasibility and value of using social media in traditional company (public and private)-specific ratings models and investor-specific ratings.

According to an embodiment, the present method/system 100 includes, e.g., creating an industry wide standard weighted credit risk model to underwrite loan and track performance.

According to an embodiment, the present method/system 100 includes, e.g., the ability to identify when a borrower exceeds borrower limits on one or more platforms.

According to an embodiment, the present method system 100 collects, consolidates, and unifies data from a plurality of separate peer-to-peer lending platforms, such as, e.g., those from China, USA, and Europe, covering consumer loans, real estate, student loans, automobiles, agribusiness, renewable energy/solar, and lifestyles, among others.

According to an embodiment, the present invention provides the following:

1. Stable automation of an API and/or web-scraping technology for each platform.

2. Collection/capture of newly incoming Loans per hour by platform.

3. Collection/capture of any update event for any Loan per hour and platform.

4. For originated loans, the loan's performance status can be followed.

5. Distinction of Loans having:
a. Loan Progress smaller than 100%−Loan is in the ‘ask’ phase, no binding contract between two parties=>indicates the ‘ask’ volume in the market.
b. Loan Progress equals 100%−Loan is an active, binding legal contract between two parties=>gives the loan/credit volume in the market.

According to an embodiment, the present method/system 100 includes incorporating a method for identifying credit risk having the objective of identifying explanatory variables for predicting if a loan is likely to be repaid or not.

The following Data and Subsets provide an example of the method used for predicting if a loan is likely to be repaid of not, according to an embodiment of the present invention.

Data: XYZ Platform originated loan data, containing all loans issued between January 2010 and September 2016, with a latest loan status as of a publication date. Two subsets of loans—all having completed their life cycles, with loan status either “Fully Paid” or “Charged Off”—having been analysed.

Subset 1: Three and five year loans issued between January 2010 and November 2011 (30986 loans, 15% defaulted).

Subset 2: Three year loans issued between January 2010 and December 2013 (166267 loans, 12% defaulted).

Model: A logistic regression model on loan status as dependent variable. Different subsets of independent variables have been built from the following attributes (as shown in Table 1):

TABLE 1

| Attribute | Description |
|---|---|
| Dti | Debt-to-income ratio in percent |
| emp_length | Employment length, coded from 0.5 to 10 |
| annual_inc | Annual income in 10 thousand USD |
| verification_status | Verified or not verified |
| home_ownership | The home ownership status provided by the |
| | borrower during registration: RENT, OWN, |
| | MORTGAGE, OTHER |
| Purpose | Purpose of loan, categorized: debt |
| | consolidation, credit card, other |
| total_acc | The total number of credit lines currently |
| | in the borrower's credit file |
| open_acc | The number of open credit lines in the |
| | borrower's credit file |
| revol_util | Revolving line utilization rate in per percent |
| revol_bal | Total credit revolving balance in 10 thousand |
| | USD |
| delinq_2yrs | The number of 30+ days past-due incidences |
| | of delinquency in the borrower's credit file |
| | for the past 2 years |
| mths_since_last_delinq | The number of months since the borrower's |
| | last delinquency |
| pub_rec_bankruptcies | Number of public record bankruptcies |
| pub_rec | Number of derogatory public records |
| mths_since_last_record | The number of months since the last public |
| | record |
| inq_last_6mths | The number of inquiries in past 6 months |
| | (excluding auto and mortgage inquiries) |

Result: So far, no attribute subset resulted in a model that calculates default probabilities matching the observed defaults in the originated loan data. None of the attributes seem to have much influence on loan status. To further analyse this issue, correlations between loan status and several attributes—such as “dti” (debt-to-income ratio)—have been calculated. For example, the correlation between dti and loan status in data subset 2 is only 0.09, which is very low.

Explanation: XYZ Platform has already used these attributes to differentiate between “good” and “bad” loans, where “good” loans are the ones they originated; they declined about 90% of all loan applications. So the data we analyse contain only the “Top 10%”, exemplified by the debt-to-income ratio that remains below 35% in all 2010 to 2013 loans. In the declined loans data, for the same time interval, we find more than 200,000 dti values higher than 40% and up to 1000%. (Debt-to-income ratio is the only attribute in the declined loans data set that can be compared with originated loans.)

So it seems that other attributes would be needed to explain the defaults in the originated loans. These could be, for example, indicators related to health or unemployment risks.

Another example is provided below:

Estimators for a parameter subset, using a sample of 5000 loans (4300 fully paid, 700 charged oil), using R (as shown in Table 2):

TABLE 2

| | |
|---|---|
| (Intercept) | −2.64400000 |
| open_acc | 0.01046000 |
| revol_util | 0.01275000 |
| revol_bal | −0.05051000 |
| delinq_2yrs | 0.16580000 |
| Dti | 0.01498000 |
| pub_rec | 0.02689000 |
| pub_rec_bankruptcies | 0.50240000 |
| mths_since_last_delinq | −0.00008213 |
| mths_since_last_record | −0.00243300 |
| inq_last_6mths | 0.18150000 |

Resulting default probabilities by quartiles and corresponding observed defaults, applied to complete dataset of 30,086 loans (26,636 fully paid/4,350 charged off) (as shown in Table 3):

TABLE 3

| | Avg. Default | Observed |
|---|---|---|
| Quartile | Probability | Defaults |
| 1 | 0.07956000 | 635 |
| 2 | 0.11552061 | 959 |
| 3 | 0.15109106 | 1152 |
| 4 | 0.21471763 | 1604 |

For comparison: Default probabilities by quartzes and corresponding observed defaults from a bank's dataset of 300 loans (255 fully paid/45 charged off) (as shown in Table 4):

TABLE 4

| | AvDefault | Observed |
|---|---|---|
| Quartile | Probability | Defaults |
| 1 | 0.00074791 | 0 |
| 2 | 0.00771929 | 1 |
| 3 | 0.06760546 | 3 |
| 4 | 0.62146373 | 41 |

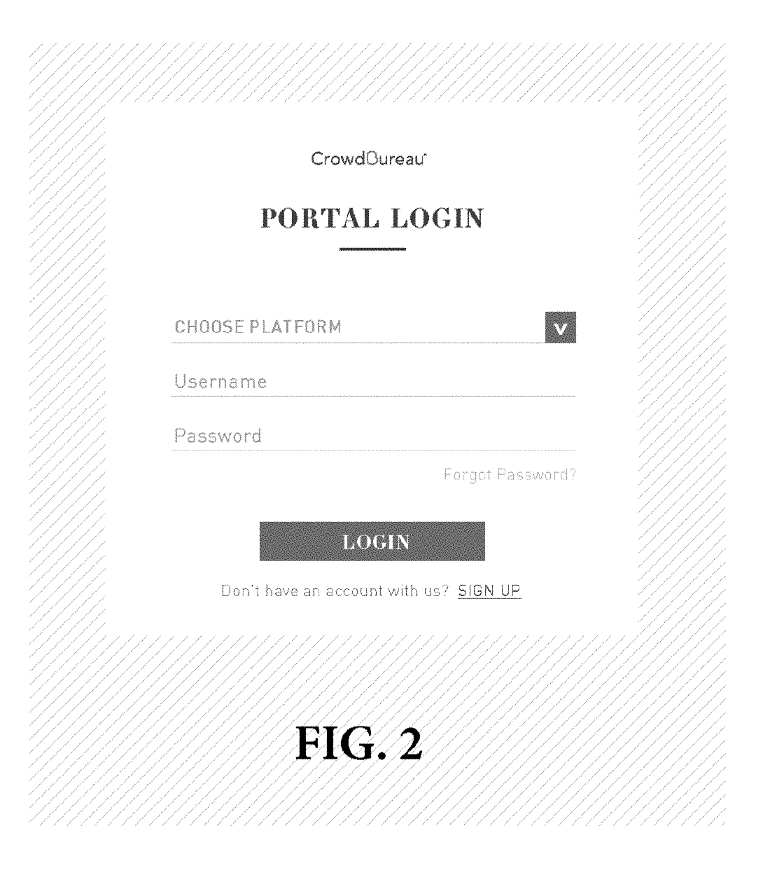

Referring now to FIG. 2, a screenshot of a login screen for a digital application for analyzing crowdfunding platforms is illustratively depicted, in accordance with an embodiment of the present invention.

According to an embodiment, one or more of the steps and/or functions as shown and described in FIG. 1 may be completed using the digital application. According to an embodiment, the digital application is capable of being run on an electronic device such as, but not limited to, a desktop computer, a laptop computer, a tablet computer, a smartphone, and/or any other suitable electronic device. According to an embodiment, one or more electronic devices are connected via a server via a wired and/or wireless connection. According to an embodiment, a memory may be coupled to the electronic device and/or the server for storing one or more pieces of data and/or the digital application.

According to an embodiment, the login screen for the digital application enables users to input login credentials (e.g., a username, a password, etc.) and a specific technology platform.

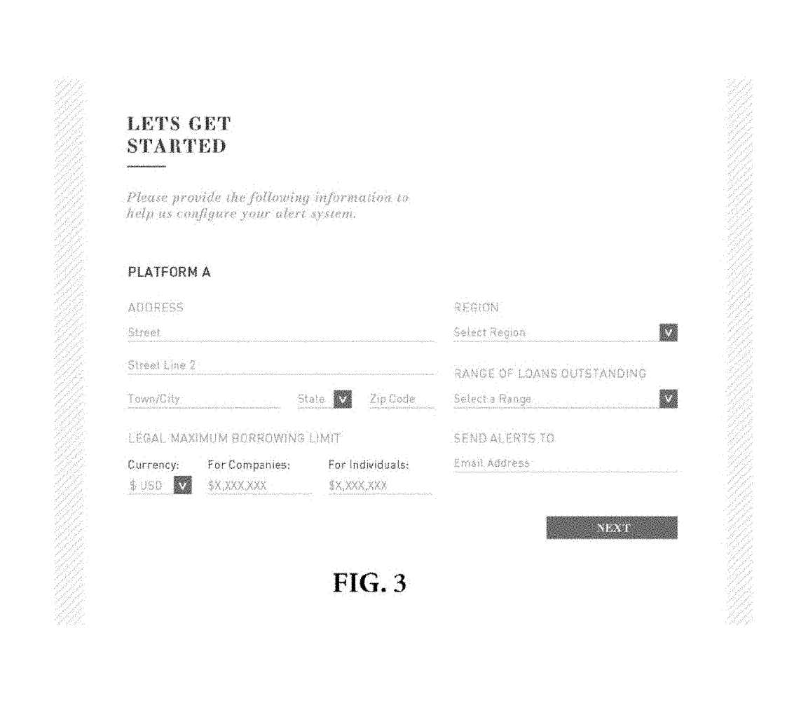

Referring now to FIG. 3, a screenshot of an alert system configuration screen for the digital application for analyzing crowdfunding platforms is illustratively depicted, in accordance with an embodiment of the present invention.

According to an embodiment, the user is able to configure the digital application to send alerts to the user. According to an embodiment, the configuration includes inputting information for the platform. This information may include, e.g., an address, a region, a range of loans outstanding, a legal maximum borrowing limit, an address (digital or physical) to which to send alerts, and/or any other suitable information.

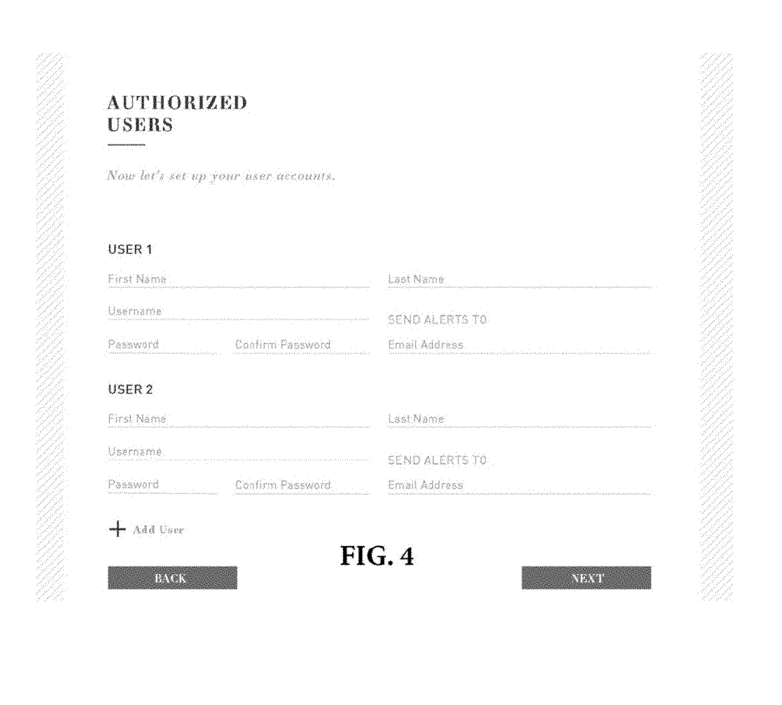

Referring now to FIG. 4, a screenshot for setting up a user account for the digital application for analyzing crowdfunding platforms is illustratively depicted, in accordance with an embodiment of the present invention.

According to an embodiment, the user account configuration includes inputting identifiable information including, e.g., name, login credentials, e-mail address, and/or any other suitable information. According to an embodiment, more than one user account can be configured.

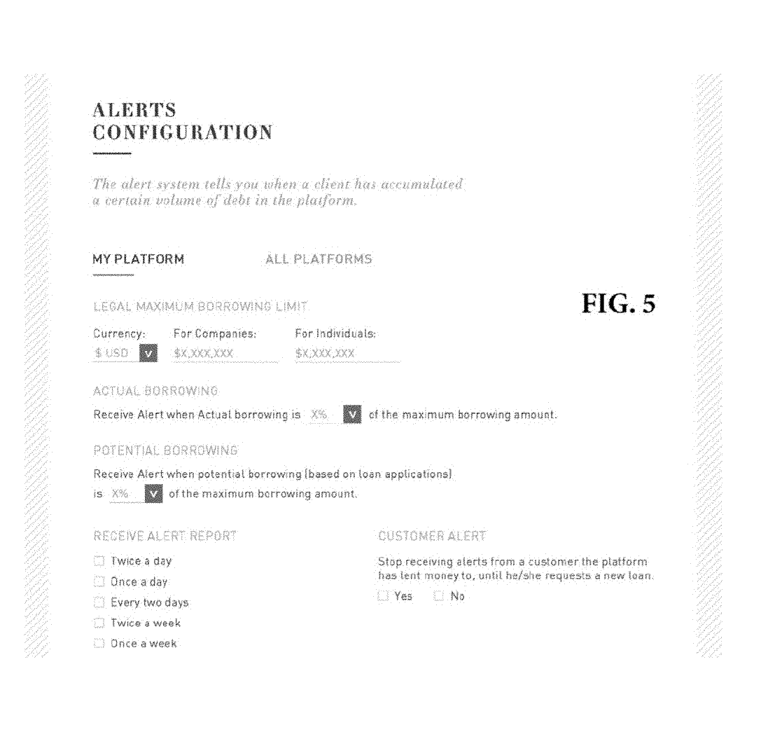

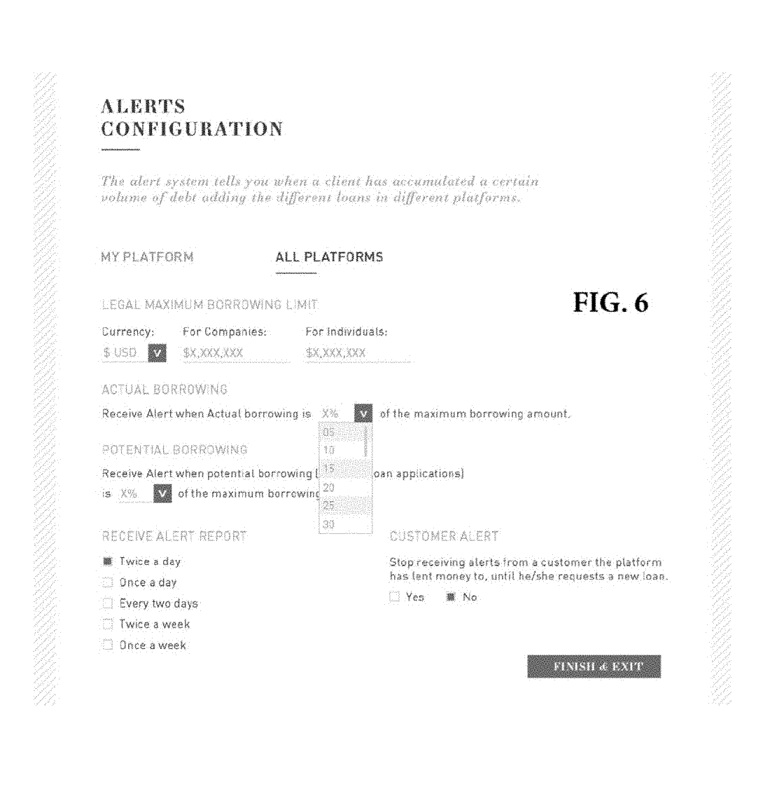

Referring now to FIGS. 5-6, screenshots for configuring alerts for the digital application for analyzing crowdfunding platforms is illustratively depicted, in accordance with various embodiments of the present invention.

According to an embodiment, users are able to configure alerts for a particular platform (FIG. 5) or for all platforms (FIG. 6). According to an embodiment, the configuration includes setting a legal maximum borrowing limit, setting up to receive alerts when actual borrowing reaches a certain amount or percentage of the maximum borrowing amount, setting up to receive alerts when potential borrowing reaches a certain amount or a certain percentage of the maximum borrowing amount, and at what interview alerts are to be received. According to an embodiment, the user may also configure alerts such that users stop receiving alerts from a customer the platform has lent money to until the customer requests a new loan.

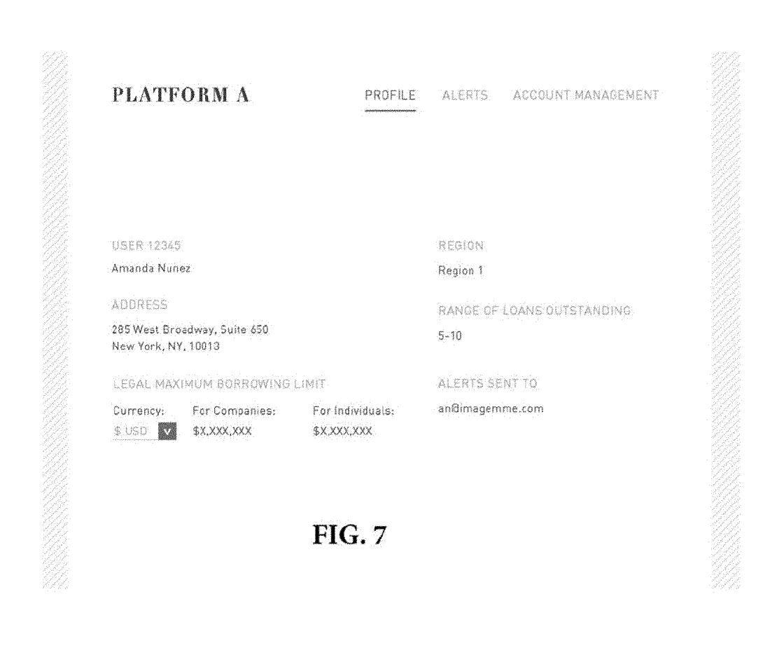

Referring now to FIG. 7, a screenshot of a profile in a platform, using the digital application for analyzing crowdfunding platforms is illustratively depicted, in accordance with an embodiment of the present invention.

According to an embodiment, the profile includes identifiable information pertaining to the identity associated with the profile, such as, e.g., name, address, region, range of loans outstanding, legal maximum borrowing limit, and an address (digital or physical) to which alerts are to be sent.

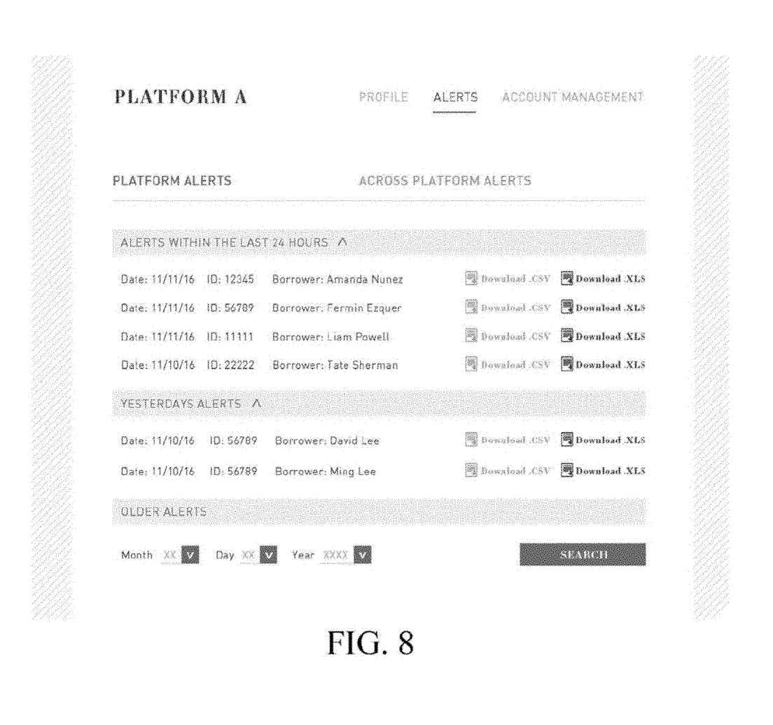

Referring now to FIG. 8, a screenshot of alerts for a platform, using the digital application for analyzing crowdfunding platforms is illustratively depicted, in accordance with an embodiment of the present invention.

According to an embodiment, alerts are organized by date received and are listed and the borrower's unique identifier listed in the alert. According to an embodiment, the user is able to search for alerts according to a specific timeframe.

Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways though which instructions (e.g., binary encoded signals) may travel to effect communications, operations, storage, etc. Optionally, the computer systemization may be connected to an infernal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)): Broadcom BCM4329FKUBG transceiver chip (e.g., providing 802.11n, Bluetooth 2.1+EDR. FM, etc.): a BroadcomBCM4750IUB8 receiver chip (e.g., GPS); an Infineon Technologies X-GoM 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processors). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST'S R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)XSA), Micro Channel Architecture (MCA), NuBus, Peripheral Component Interconnect (Extended) (PCT(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel. Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like, Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB; infrared; joystick; keyboard; midi: optical; PC AT; PS/2; parallel; radio; video interface: Apple Desktop Connector (ADC), BNC, coaxial, component, composite, digital; Digital Visual Interface (DVI; high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE, WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable: a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors: nCipher's nShield, SafeNet's Luna PCI (e.g., 7100) series: Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C #and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components though facilities such as ASP, ActiveX, (ANSI) (Objective-) C (++), C # and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like. A beverages table including, for example, heat capacities and other useful parameters of different beverages, such as depending on size beverage_name, beverage_size, desired_coolingtemp, cooling_time, favorite_drinker, number_of_beverages, current_beverage_temperature, current_ambient_temperature, and/or the like. A Parameter table may include fields including the foregoing fields, or additional ones such as cool_start_time, cool_preset, cooling_rate, and/or the like. A Cool Routines table may include a plurality of cooling sequences may include fields such as, but not limited to: sequence_type, sequence_id, flow_rate, avg_water_temp, cooling_time, pump_setting, pump_speed, pump_pressure, power_level, temperature_sensor_id__number, temperature_sensor_location, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for analyzing crowdfunding platforms, the method comprising:
connecting, using an electronic device, to a plurality of individual lending platforms; retrieving loan book data from each of the individual lending platforms; storing the loan book data, using a memory coupled to the electronic device,
wherein the loan book data includes metadata generated in a Structured Query Language database, and
wherein the metadata includes a name of a platform associated with the loan book data and a list of data attributes;
transforming, using a processor coupled to the electronic device, the loan took data from each of the platforms such that the transformed loan book data uses common data;
reading, using the processor, the transformed loan book data; and
documenting, for each pair of platform and attribute, a destination unified data attribute.

2. The method as recited in claim 1, wherein the metadata further includes a timestamp for when the loan book data has been received.

3. The method as recited in claim 1, wherein the list of attributes is associated with each borrower listing and loan origination associated with the platform.

4. The method as recited in claim 1, wherein the common data is selected from the group consisting of: a common language; a common currency; a common time zone; common units; and common numeric ranges.

5. The method as recited in claim 1, wherein the storing the loan book data further includes storing the loan book data, for each platform, in its natural state, in real time.

6. The method as recited in claim 1, wherein the documenting is performed according to a mapping table.

7. The method as recited in claim 1, further comprising predicting if a loan associated with a platform is likely to be repaid or not.

8. A system for analyzing crowdfunding platforms, the system comprising:
an electronic device configured to:
connect to a plurality of individual lending platforms; and
retrieve loan book data from each of the individual lending platforms;
a memory coupled to the electronic device, the memory configured to store the loan book data,
wherein the loan book data includes metadata generated in a Structured Query Language database, and
wherein the metadata includes a name of a platform associated with the loan book data and a list of data attributes; and
a processor, coupled to the electronic device, the processor configured to:
transform the loan book data from each of the platforms such that the transformed loan book data uses common data;
read the transformed loan book data; and
document, for each pair of platform and attribute, a destination unified data attribute.

9. The system as recited in claim 8, wherein the metadata further includes a timestamp for when the loan book data has been received.

10. The system as recited in claim 8, wherein the list of attributes is associated with each borrower listing and loan origination associated with a primary platform listed and identified across other platforms.

11. The system as recited in claim 8, wherein the common data is selected from the group consisting of: a common language; a common currency; a common time zone; common units; and common numeric ranges.

12. The system as recited in claim 8, wherein the memory if further configured to store the loan book data, for each platform, in its natural state, in real time.

13. The system as recited in claim 8, wherein the processor is configured to document according to a mapping table.

14. The system as recited in claim 8, wherein the processor is further configured to predict if a loan associated with a platform is likely to be repaid or not.

15. The system as recited in claim 8, wherein the electronic device is selected from the group consisting of: a desktop computer; a laptop computer; a tablet computer; and a smartphone.

16. The system as recited in claim 8, further comprising a graphical user interface, and wherein the memory is further configured to store a digital application configured to enable a user to access the destination unified data attributes, using the graphical user interface.
